(19) United States
(12) Patent Application Publication
(10) Pub. No.: US 2024/0171782 A1
(43) Pub. Date: May 23, 2024

(54) LIVE STREAMING METHOD AND SYSTEM BASED ON VIRTUAL IMAGE

(71) Applicant: SHANGHAI BILIBILI TECHNOLOGY CO., LTD., Shanghai (CN)

(72) Inventor: Hongwei LIU, Shanghai (CN)

(21) Appl. No.: 18/513,450

(22) Filed: Nov. 17, 2023

(30) Foreign Application Priority Data
Nov. 18, 2022 (CN) 202211453415.5

(51) Int. Cl. H04N 21/2187; G06T 13/40; G06T 19/20; G10L 25/63

(52) U.S. Cl. CPC H04N 21/2187; G06T 13/40; G06T 19/20; G10L 25/63; G06T 2219/2004

(57) ABSTRACT

The present application discloses techniques for live streaming based on virtual images. The techniques comprise providing a live streaming interface, the live streaming interface including a virtual character; generating a target motion instruction for the virtual character, the target motion instruction being generated based on an input operation other than image capture; and controlling, in response to the target motion instruction, the virtual character to perform a target motion associated with the target motion instruction. According to the techniques of the present application, few computing resources are occupied.

### CROSS-REFERENCE TO RELATED APPLICATION

The present application claims priority to Chinese Patent Application No. 202211453415.5, filed on Nov. 18, 2022, which is incorporated herein by reference in its entirety.

### TECHNICAL FIELD

The present application relates to the field of computer technologies, and in particular, to a live streaming method and system based on a virtual image, a computer device, and a computer-readable storage medium.

### BACKGROUND ART

With the development of computer technologies, live streaming and other services have become popular network services at present. In living streaming, an online streamer may not want to show his or her real images for various reason. Improvements in living streaming are desired.

### SUMMARY OF THE INVENTION

An objective of embodiments of the present application is to provide a live streaming method and system based on a virtual image, a computer device, and a computer-readable storage medium, to solve the problem described above.

An aspect of the embodiments of the present application provides a live streaming method based on a virtual image, including:
providing a live streaming interface, the live streaming interface including a virtual character;
obtaining a target motion instruction for the virtual character, the target motion instruction being obtained based on an input operation other than image capture; and
controlling, in response to the target motion instruction, the virtual character to perform a target motion associated with the target motion instruction.

Optionally, the input operation includes at least one of the following: a keyboard input, a mouse input, a touchpad input, a voice/text input, a random animation, and a program-setting-based automatic blink.

Optionally, the obtaining a target motion instruction for the virtual character includes:
obtaining a target input signal from a physical device, the physical device comprising a physical keyboard, a physical mouse, and/or a physical touchpad; and
determining the target motion instruction based on the target input signal, different input signals corresponding to different motion instructions.

Optionally, the live streaming interface further includes a virtual keyboard. The virtual keyboard is floatable in front of the virtual character, and is configured to interact with a hand of the virtual character.

The determining the target motion instruction based on the target input signal includes:
determining a target virtual button of the virtual keyboard when the target input signal is generated by the physical keyboard;
determining a target finger of the virtual character based on the target virtual button; and
determining the target motion instruction based on the target virtual button and the target finger.

The target motion instruction is used for instructing the virtual character to tap the target virtual button with the target finger.

Optionally, the live streaming interface further includes a virtual mouse. The virtual mouse is floatable beside the virtual character, and is configured to interact with a hand of the virtual character.

The determining the target motion instruction based on the target input signal includes:
determining a target hand in which the virtual mouse is located when the target input signal is generated by moving the physical mouse; and
determining the target motion instruction based on a location change of the physical mouse, wherein

The target motion instruction is used for instructing the virtual character to move the target hand by simulating the physical mouse.

Optionally, the live streaming interface further includes a virtual mouse. The virtual mouse is floatable beside the virtual character, and is configured to interact with a hand of the virtual character.

The determining the target motion instruction based on the target input signal includes:
determining a target virtual button of the virtual mouse when the target input signal is generated by a button of the physical mouse;
determining a target finger of the virtual character; and
determining the target motion instruction based on the target virtual button and the target finger.

The target motion instruction is used for instructing the virtual character to click the virtual mouse with the target finger.

Optionally, the method further includes:
obtaining a random blink instruction for the virtual character, so as to control an eye motion of the virtual character.

Optionally, the method further includes:
obtaining a random motion instruction for the head or the upper body of the virtual character, so as to control a motion of the head or the upper body of the virtual character.

Optionally, the method further includes:
blending a facial expression motion corresponding to a target emotion with an animation status of the virtual character when the target emotion of the virtual character is determined, different emotions corresponding to motions of different parts of the virtual character.

Optionally, an operation of determining the target emotion includes:
obtaining a voice audio signal from a target object;
determining an emotion of the target object based on an acoustic feature of the voice audio signal; and
determining the target emotion based on the emotion of the target object, the target emotion being the same as or corresponding to the emotion of the target object.

Optionally, the method further includes:
performing frequency domain conversion on the voice audio signal to obtain a spectrum;
determining a formant on the spectrum;
determining a vowel in the voice audio signal based on the formant;
determining, based on the vowel, a mouth shape corresponding to the voice audio signal; and
determining a mouth motion instruction based on the mouth shape, where the mouth motion instruction is used for instructing a mouth motion of the virtual character.

An aspect of the embodiments of the present application also provides a live streaming system based on a virtual image, including:
a provision module configured to provide a live streaming interface, the live streaming interface comprising a virtual character;
an obtaining module configured to obtain a target motion instruction for the virtual character, the target motion instruction being obtained based on an input operation other than image capture; and
a control module configured to control, in response to the target motion instruction, the virtual character to perform a target motion associated with the target motion instruction.

An aspect of the embodiments of the present application further provides a live streaming method based on a virtual image, including:
displaying a virtual live streamer interface, the virtual live streamer interface comprising a virtual character and a virtual keyboard floating in front of the virtual character; and
displaying, in response to an operation for a physical keyboard, a first animation effect that the virtual character operates the virtual keyboard, where the first animation effect includes that the virtual character taps a target virtual button with a corresponding finger, and the target virtual button corresponds to an operated button of the physical keyboard.

Optionally, the virtual live streamer interface includes a virtual mouse. The method further includes:
displaying, in response to an operation for a physical mouse, a second animation effect that the virtual character operates the virtual mouse.

When the physical mouse is moved, the second animation effect includes that the virtual character moves a target hand and the virtual mouse by simulating the physical mouse. When a mouse button of the physical mouse is triggered, the second animation effect includes that the virtual character clicks the virtual mouse with a corresponding finger.

Optionally, the method further includes:
displaying an animation effect of a blink of the virtual character in response to a random blink instruction for the virtual character.

Optionally, the method further includes:
displaying an animation effect of the head or the upper body of the virtual character in response to a random motion instruction for the virtual character.

Optionally, the method further includes:
displaying an animation effect of the face or the mouth of the virtual character in response to an analysis result of a voice signal from a target object.

An aspect of the embodiments of the present application further provides a computer device, including a memory, a processor, and a computer program stored in the memory and executable on the processor, where the processor, when executing the computer program, implements the steps of the live streaming method based on a virtual image as described above.

An aspect of the embodiments of the present application further provides a computer-readable storage medium, storing a computer program, where the computer program may be executed by at least one processor to cause the at least one processor to perform the steps of the live streaming method based on a virtual image as described above.

The live streaming method and system based on a virtual image, the computer device, and the computer-readable storage medium provided in the embodiments of the present application may have the following technical effects. A target motion instruction may be generated based on an input operation other than image capture. For example, the target motion instruction may be accurately generated by conversion of a voice to a mouth shape, adjustment of a facial expression through voice-based emotion recognition, a random animation, a posture of tapping a keyboard or moving a mouse, a program-based automatic blink, or the like, without using a facial capture system/motion capture system. Therefore, according to the embodiments of the present application, a virtual character may be driven without facial capture or motion capture data, which may be more friendly, convenient, and suitable particularly for a live streamer for a game zone. Facial capture and motion capture are not used, so that occupied computing resources are greatly reduced.

### BRIEF DESCRIPTION OF THE DRAWINGS

FIG. 1 is a diagram schematically showing an application environment of a live streaming method based on a virtual image according to an embodiment of the present application;

FIG. 2 is a flowchart schematically showing a live streaming method based on a virtual image according to Embodiment 1 of the present application;

FIG. 3 is a flowchart schematically showing sub-steps of step S202 in FIG. 2;

FIG. 4 schematically shows a display effect of a live streaming picture;

FIG. 5 is a flowchart schematically showing sub-steps of step S202 in FIG. 3;

FIG. 6 is another flowchart schematically showing sub-steps of step S202 in FIG. 3;

FIG. 7 is another flowchart schematically showing sub-steps of step S202 in FIG. 3;

FIG. 8 schematically shows another display effect of a live streaming picture;

FIG. 9 is a flowchart schematically showing a live streaming method based on a virtual image according to Embodiment 2 of the present application;

FIG. 10 is a block diagram schematically showing a live streaming system based on a virtual image according to Embodiment 3 of the present application;

FIG. 11 is a block diagram schematically showing a live streaming system based on a virtual image according to Embodiment 4 of the present application; and

FIG. 12 is a schematic diagram schematically showing a hardware architecture of a computer device suitable for implementing a live streaming method based on a virtual image according to Embodiment 5 of the present application.

### DETAILED DESCRIPTION OF EMBODIMENTS

To make the objectives, technical solutions, and advantages of the present application clearer and more comprehensible, the present application will be further described in detail with reference to the accompanying drawings and embodiments. It should be understood that the specific embodiments described herein are merely intended to explain the present application, and are not intended to limit the present application. All other embodiments obtained by those of ordinary skill in the art based on the embodiments of the present application without creative efforts shall fall within the protection scope of the present application.

It should be noted that the descriptions related to “first”, “second”, and the like in the embodiments of the present application are merely for the illustrative purpose, and should not be construed as indicating or implying the relative importance thereof or implicitly indicating the number of technical features indicated. Therefore, a feature defined by “first” or “second” may explicitly or implicitly includes at least one such feature. In addition, technical solutions of various embodiments of the present application can be combined with each other, but they are required to be based on the implementation by those of ordinary skill in the art. When a combination of technical solutions is contradictory or cannot be implemented, it should be considered that such a combination of the technical solutions neither exists, nor falls within the protection scope claimed by the present application.

In the description of the present application, it should be understood that the reference numerals of steps do not indicate the order of execution of the steps, but are merely to facilitate the description of the present application and differentiation between the steps, and thus will not be interpreted as limiting the present application.

Terms in the present application are explained below.

BlendShapes is an animation production method for calculating a difference between vertex data of a plurality of different mesh bodies, and is mainly applied to a small local motion, for example, a facial expression of a character.

Facial capture means capture for a facial expression, a blink, a mouth shape, and the like.

Motion capture records a motion of an observed object (a person, an object, or an animal), and performs effective processing. Motion capture is a new technology through which various moving tracks and postures of a moving object in physical three-dimensional space may be accurately measured and recorded in real time and a movement status of this object at each moment is reconstructed in virtual three-dimensional space.

To help those skilled in the art understand the technical solutions provided in the embodiments of the present application, the following describes related technologies.

With the development of a computer vision technology, a virtual image has entered the public's vision by live streaming and favored by more and more users. A video platform may provide techniques for quickly generating a humanoid avatar of a content producer and integrating the humanoid avatar into content creation. For example, in virtual live streaming, a live streamer may configure a virtual image of the live streamer to replace a real image of the live streamer. Virtual live streaming may depend on facial capture and motion capture, and uses a facial expression and a motion of the live streamer to drive the virtual image. But such camera-picture-based image capture requires high computing resource consumptions.

Virtual live streaming depends on facial capture and motion capture, and uses a facial expression and a motion of a live streamer in the virtual image. The industry provides a marker-based or marker-free facial motion capture system, a motion capture suit or gloves for motion capture, and the like. To lower a threshold for starting live streaming, various live streaming platforms further provide 2D camera picture-based capture, greatly reducing the live streaming threshold for normal users. However, 2D camera picture-based capture has poor recognition effects, for example, a poor match degree between a mouth shape and an actual voice. In addition, recognition is generally based on computer vision or deep learning, which is a heavy burden for a medium/low-performance computer device. Some game live streamers wants only a humanoid avatar for limited interaction without facial capture or motion capture.

In view of this, the present application provides a live streaming method based on a virtual image. A body motion and a facial expression of a virtual character may be driven to change based on other obtained information. For example, facial-capture-free virtual live streaming may be started by conversion of a voice to a mouth shape, adjustment of a facial expression through voice-based emotion recognition, a random animation, a posture of tapping a keyboard or moving a mouse, or a program-based automatic blink, and the virtual character is driven without facial capture or motion capture data, which is friendly, convenient, and suitable particularly for a live streamer for a game zone. Facial capture and motion capture are not used, so that occupied computing resources of a computer are greatly reduced. A deterministic motion can be more accurately displayed, for example, a motion of tapping the keyboard or the program-based automatic blink. Multi-dimensional driving ensures rich motions and facial expressions.

The following provides an exemplary application environment of the embodiments of the present application.

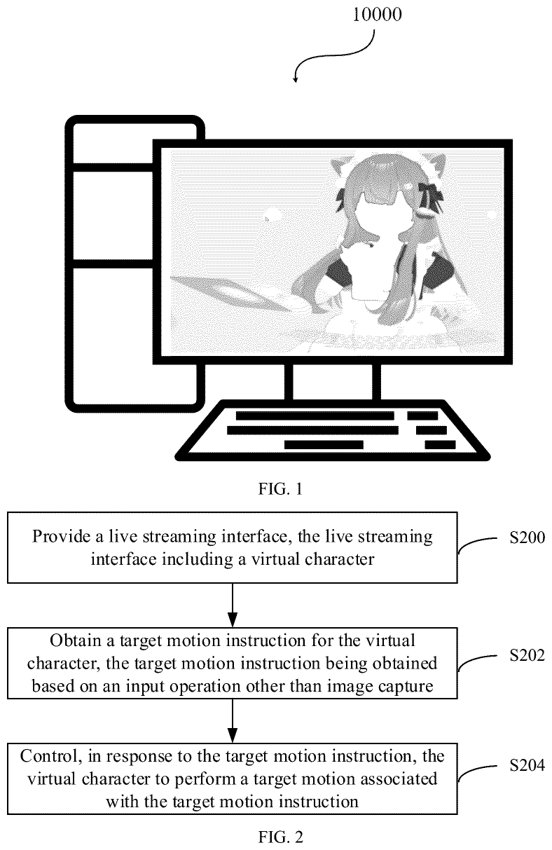

FIG. 1 is a diagram schematically showing environmental application of a live streaming method based on a virtual image according to an embodiment of the present application.

A computer device 10000 may be a terminal device such as a smartphone, a tablet device, or a personal computer (PC). The computer device 10000 is installed with a virtual live streaming tool configured to display a virtual image. The virtual live streaming tool may provide a related operation interface. The virtual live streaming tool may be a client program, a browser, or the like.

As shown in FIG. 1, the virtual live streaming tool may further provide various functions of importing, adjusting, and the like of the virtual image. Based on these functions, a user may adjust a display effect by using a gesture or an input instruction in another form. The interface shown in FIG. 1 is merely an example. In actual applications, the interface of the virtual live streaming tool may be more appropriate.

The following describes a live streaming solution based on a virtual image by using a plurality of embodiments. The solution may be implemented by the computer device 10000.

### Embodiment 1

FIG. 2 is a flowchart schematically showing a live streaming method based on a virtual image according to Embodiment 1 of the present application. As shown in FIG. 2, the live streaming method based on a virtual image may include steps S200 to S204.

In step S200, a live streaming interface is provided, the live streaming interface including a virtual character.

In step S202, a target motion instruction for the virtual character is obtained, the target motion instruction being obtained based on an input operation other than image capture.

In step S204, the virtual character is controlled, in response to the target motion instruction, to perform a target motion associated with the target motion instruction.

According to the live streaming method based on a virtual image provided in this embodiment of the present application, the target motion instruction may be generated based on an input operation other than image capture. For example, the target motion instruction may be accurately generated by conversion of a voice to a mouth shape, adjustment of a facial expression through voice-based emotion recognition, a random animation, a posture of tapping a keyboard or moving a mouse, a program-based automatic blink, or the like, without using a facial capture system/motion capture system. Therefore, according to this embodiment, a virtual character may be driven without facial capture or motion capture data, which is more friendly, convenient, and suitable particularly for a live streamer for a game zone. Facial capture and motion capture are not used, so that occupied computing resources are greatly reduced.

The following describes each of steps S200 to S204 in detail with reference to FIG. 1.

In step S200, the live streaming interface is provided, the live streaming interface including the virtual character.

The computer device 10000 may provide the virtual live streaming tool. The virtual live streaming tool provides the live streaming interface shown in FIG. 1. In an example, the live streaming interface may be a combination of a virtual scene and a plurality of virtual elements, or may be a combination of a real scene and a plurality of virtual elements. In specific applications, this may be determined according to a choice of the user.

In some embodiments, the computer device 10000 may alternatively select a required virtual character from a cloud.

In some embodiments, the computer device 10000 may alternatively load a local virtual image file to the virtual live streaming tool.

In addition to a person-based virtual character, the live streaming interface may further include various other virtual objects, for example, a pet.

In step S202, the target motion instruction for the virtual character is obtained, the target motion instruction being obtained based on the input operation other than image capture.

To reduce a computing resource consumption of the computer device 10000, in this embodiment, image capture (for example, motion capture or facial capture) is not used, and instead, another input operation is used to generate the target motion instruction. It should be noted that image capture and the another input operation may both be used, depending on a situation. For example, if the computer device 10000 is in a preset computer state (for example, idle), image capture and the another input operation may both be used. If the computer device is not in a preset computer state, image capture is not used. In some embodiments, a priority may be set, or the input operation is used when no motion or expression change is recognized within a specific time.

The input operation other than image capture includes, but is not limited to various inputs such as a (physical) keyboard input, a (physical) mouse input, a (physical) touchpad input, a voice/text input, a random animation, and a program-setting-based automatic blink.

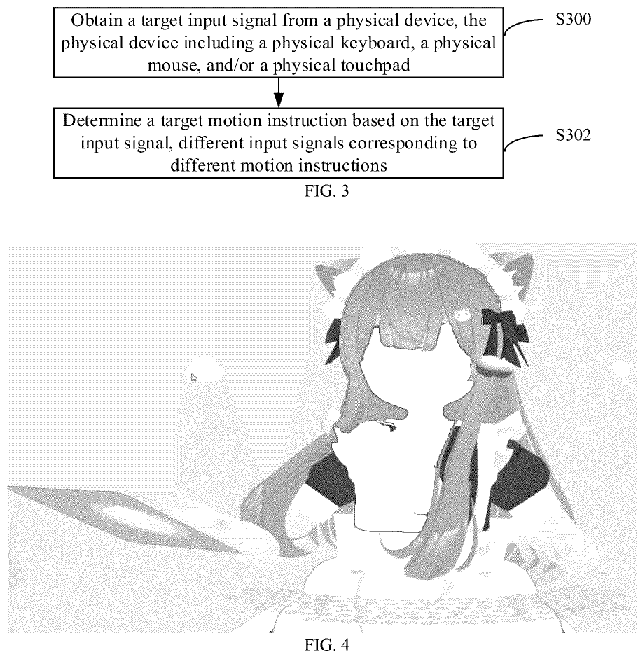

In an optional embodiment, as shown in FIG. 3, step S202 may include the following steps.

In step S300, a target input signal from a physical device is obtained, the physical device including a physical keyboard, a physical mouse, and/or a physical touchpad.

In step S302, the target motion instruction is determined based on the target input signal, different input signals corresponding to different motion instructions.

Unlike image capture with nondeterminacy and an error rate, generating a more accurate motion instruction based on these physical devices not only reduces the computing resource consumption, but also may more accurately display a deterministic motion. It should be noted that the above physical device may alternatively be various other electronic devices, for example, a remote controller or an electronic device with a button or another function, such as a smartphone or a tablet computer, and the electronic device may display a virtual keyboard for interaction with the user, or the like.

In an optional embodiment, the live streaming interface further includes a virtual keyboard. As shown in FIG. 4, the virtual keyboard is floatable in front of the virtual character, and is configured to interact with a hand of the virtual character. A style, a shape, and a location of the virtual keyboard may be selected or configured by the user, or may be randomly configured. In some embodiments, the computer device 10000 may configure a corresponding virtual keyboard based on an external physical keyboard. Still referring to FIG. 4, the virtual keyboard is placed flat in front of the virtual character, and has non-transparent buttons but a transparent non-button region. Such a setting may create a floating and science fiction visual effect, thereby improving experience of an audience.

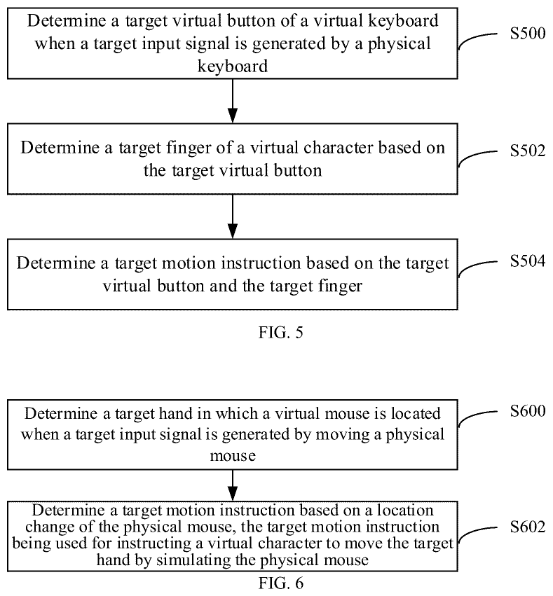

As shown in FIG. 5, step S302 of “determining the target motion instruction based on the target input signal” may include the following steps. In step S500, a target virtual button of the virtual keyboard is determined when the target input signal is generated by the physical keyboard. In step S502, a target finger of the virtual character is determined based on the target virtual button. In step S504, the target motion instruction is determined based on the target virtual button and the target finger. The target motion instruction is used for instructing the virtual character to tap the target virtual button with the target finger. For example, if it is detected that a button “T” of the physical keyboard is triggered, it is determined that the target virtual button is the button “T”. If a finger for tapping the button “T” is set to be the left index finger, a corresponding target motion instruction may be generated. The target motion instruction may be a single instruction or an instruction set. The instruction set includes motion instructions from an initial state to a final state when the virtual character taps the button “T”, for example, a motion instruction for the hand of the virtual character and a motion instruction for the left index finger. To further improve the visual effect and the sense of reality, the instruction set may further include a coordinated motion instruction for the head, the eyes, the shoulders, and the like in a process of tapping the button “T”. It may be learned that in this optional embodiment, a motion of the virtual character is directly combined to implement accurate linkage between the virtual character and the physical keyboard, thereby improving experience of the audience.

In an optional embodiment, the live streaming interface further includes a virtual mouse. The virtual mouse is floatable beside the virtual character, and is configured to interact with a hand of the virtual character. There may be a virtual mouse pad or the like under the virtual mouse. As shown in FIG. 6, step S302 of “determining the target motion instruction based on the target input signal” may include the following steps. In step S600, a target hand in which the virtual mouse is located is determined when the target input signal is generated by moving the physical mouse. In step S602, the target motion instruction is determined based on a location change of the physical mouse. The target motion instruction is used for instructing the virtual character to move the target hand by simulating the physical mouse. For example, if a movement of the physical mouse is detected, a corresponding target motion instruction may be generated. The target motion instruction may be a single instruction or an instruction set. The instruction set includes performing movement simulation on a hand in which the mouse is located and the virtual mouse. It may be learned that in this optional embodiment, accurate linkage between the virtual character and the physical keyboard may be implemented, thereby improving experience of the audience.

It should be noted that the virtual mouse may alternatively not be displayed on the live streaming interface, but only the non-transparent virtual mouse pad is displayed, and a visual effect that the virtual character is moving the mouse is presented by a movement of the target hand relative to the virtual mouse pad.

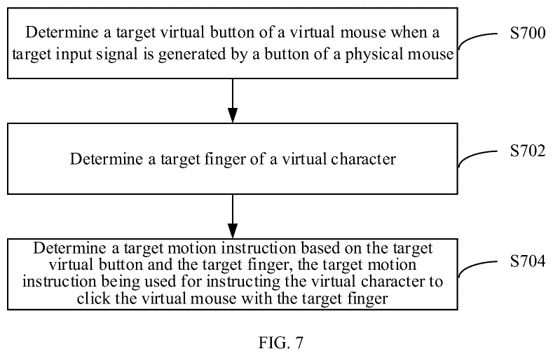

In an optional embodiment, the live streaming interface further includes a virtual mouse. The virtual mouse is floatable beside the virtual character, and is configured to interact with a hand of the virtual character. There may be a virtual mouse pad or the like under the virtual mouse. As shown in FIG. 7, step S302 of “determining the target motion instruction based on the target input signal” may include the following steps. In step S700, a target virtual button of the virtual mouse is determined when the target input signal is generated by a button of the physical mouse. In step S702, a target finger of the virtual character is determined. In step S704, the target motion instruction is determined based on the target virtual button and the target finger. The target motion instruction is used for instructing the virtual character to click the virtual mouse with the target finger. For example, the physical mouse may include a left button, a right button, a wheel, and the like. If it is detected that the left button of the physical mouse is triggered, it is determined that the target virtual button of the virtual mouse is a left button. If a finger for clicking the left button of the virtual mouse is set to be the right index finger, a corresponding target motion instruction may be generated. The target motion instruction may be a single instruction or an instruction set. The instruction set includes motion instructions from an initial state to a final state when the virtual character clicks the left button of the virtual mouse, for example, a motion instruction for the hand of the virtual character and a motion instruction for the left index finger. It may be learned that in this optional embodiment, a motion of the virtual character is directly combined to implement accurate linkage between the virtual character and the physical mouse, thereby improving experience of the audience.

The above describes the motion instructions for the virtual keyboard, the virtual mouse, and the like. It should be noted that according to a user setting, various other virtual devices may be further included, for example, a virtual touchpad, a virtual stylus, and a virtual remote controller.

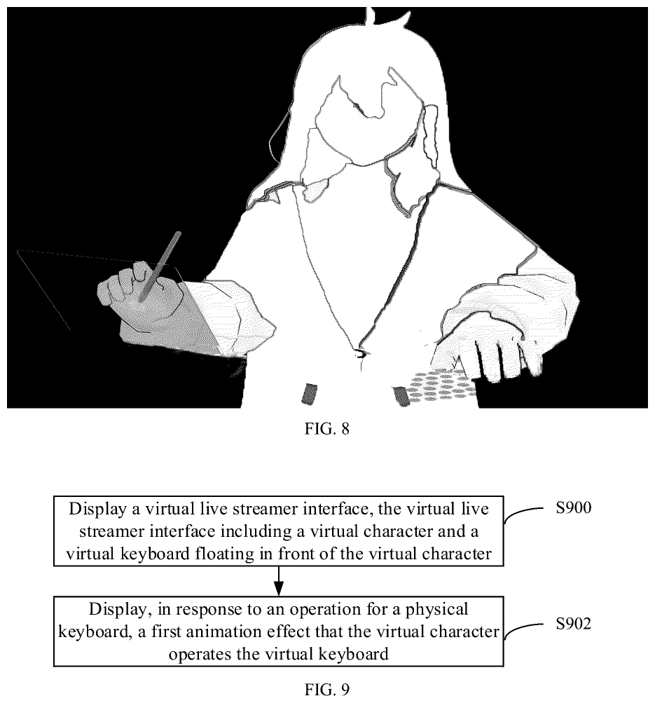

As shown in FIG. 8, the live streaming interface includes a transparent virtual touchpad and a virtual stylus. A corresponding motion instruction may be generated on the live streaming interface based on a location and an operation of a physical stylus on a physical touchpad. Further, an actual stylus holding posture of the user and a change in a stylus holding posture may be obtained based on an included angle between the physical stylus and the physical touchpad, or the like, and a motion and a posture of the hand of the virtual character relative to the virtual stylus are adjusted based on the actual stylus holding posture and a posture status, thereby further improving synchronism with the user and improving experience of the audience.

In an optional embodiment, step S202 of “obtaining a target motion instruction for the virtual character” may alternatively be implemented by the following step: obtaining a random blink instruction for the virtual character, so as to control an eye motion of the virtual character. For example, an automatic blink program is set to control a random blink within a specific range. Such a blink program implements a low resource consumption, and also ensures multi-dimensional driving for the virtual character, thereby providing good experience for the audience.

In an optional embodiment, step S202 of “obtaining a target motion instruction for the virtual character” may alternatively be implemented by the following step: obtaining a random motion instruction for the head or the upper body of the virtual character, so as to control a motion of the head or the upper body of the virtual character. In some other embodiments, when a target emotion of the virtual character is determined, a facial expression motion corresponding to the target emotion is blended with an animation status of the virtual character, different emotions corresponding to motions of different parts of the virtual character.

For example, some movements of the head or the upper body may be randomly generated by using a program. The generated random motion instruction may add an animation effect of the virtual character. In addition, different emotions correspond to motions of different parts. When the target emotion is obtained, a corresponding motion instruction is triggered and combined with a previous motion instruction to form a blended animation. Therefore, a motion of the virtual character may be more comprehensive and authentic, and experience of the audience may be improved. In some embodiments, it may be configured that a random motion is performed when no other instruction is recognized.

For example, an operation of determining the target emotion includes: obtaining a voice audio signal from a target object; determining an emotion of the target object based on an acoustic feature of the voice audio signal; and determining the target emotion based on the emotion of the target object, the target emotion being the same as or corresponding to the emotion of the target object. In an exemplary embodiment, compared with recognizing an emotion through motion or facial capture, recognizing an emotion through a voice in this embodiment not only implements a low computing resource consumption, but also more accurately recognizes a change in a mouth shape.

In an optional embodiment, the method may further provide a mouth motion instruction. The mouth motion instruction may be obtained by the following steps: performing frequency domain conversion on the voice audio signal to obtain a spectrum; determining a formant on the spectrum; determining a vowel in the voice audio signal based on the formant; determining, based on the vowel, a mouth shape corresponding to the voice audio signal; and determining a mouth motion instruction based on the mouth shape, where the mouth motion instruction is used for instructing a mouth motion of the virtual character. By using the mouth motion instruction provided in this optional embodiment, a change in the mouth shape of the virtual character may be highly matched with a change in a mouth shape of a speaker (the target object).

In specific applications, most character models store a BlendShape of five Japanese vowels A, I, E, U, and O. For a cartoon character, there is no need to consider muscular movements around the mouth shape, and the mouth shape may be driven only by deducing proportions of A, I, E, U, and O and then adjusting the BlendShape on the model. Driving by using A, I, E, U, and O for Chinese can also achieve good simulation effects to some extent.

Implementation steps may be as follows.
In (1), the vowel (the acoustic feature) in the voice audio signal is analyzed in real time.
In (2), an acoustic feature recognition result is stored in a project as a resource file, and such data is directly read during running.
In (3), a numerical animation weight is generated based on the vowel in the voice audio signal, and is assigned to the virtual character.

Based on the steps, it looks like the virtual character is actually speaking.

The “mouth shape” is a part of a vocal tract shape. This impulse response process is represented by a plurality of convex envelope peaks on the spectrum. A frequency of occurrence of these envelope peaks is referred to as a “formant frequency”, a “formant” for short. Therefore, calculating first and second formants of a piece of voice data may accurately obtain a “vowel” in this piece of voice. Calculating only the first formant may obtain a general result.

The formant may be extracted in a manner of calculating a maximum value of a local maximum value on the spectrum obtained in the previous step.

In step S204, the virtual character is controlled, in response to the target motion instruction, to perform the target motion associated with the target motion instruction.
(1) When a specific button of the physical keyboard is triggered, the target motion instruction is used for controlling the virtual character to tap a corresponding button of the virtual keyboard, thereby displaying, on the live streaming interface, a first animation effect that the virtual character operates the virtual keyboard. The first animation effect includes that the virtual character taps a target virtual button with a corresponding finger, and the target virtual button corresponds to an operated button of the physical keyboard.
(2) When the physical mouse is dragged or a specific button of the physical mouse is triggered, the target motion instruction is used for controlling the virtual character to move the virtual mouse or click a corresponding button of the virtual mouse, thereby displaying, on the live streaming interface, a second animation effect that the virtual character operates the virtual mouse. When the physical mouse is moved, the second animation effect includes that the virtual character moves a target hand and the virtual mouse by simulating the physical mouse. When a mouse button of the physical mouse is triggered, the second animation effect includes that the virtual character clicks the virtual mouse with a corresponding finger.
(3) If the random blink instruction for the virtual character is monitored, an animation effect of a blink of the virtual character is displayed.
(4) If the random motion instruction for the virtual character is monitored, an animation effect of the head or the upper body of the virtual character is displayed.
(5) If an analysis result of a voice signal from the target object is monitored, an animation effect of the face or the mouth of the virtual character is displayed.

The emotion may be obtained while the voice signal is recognized. In this way, the facial expression changes by using several prepared expressions representing, for example, pleasure, anger, sorrow, and joy while the mouth shape changes in real time.

The above describes the technical solution in this embodiment. The live streaming method based on a virtual image provided in this embodiment has the following advantages.

A body motion and a facial expression of a virtual character are driven to change based on other obtained information. For example, facial-capture-free virtual live streaming may be started by conversion of a voice to a mouth shape, adjustment of a facial expression through voice-based emotion recognition, a random animation, a posture of tapping a keyboard or moving a mouse, or a program-based automatic blink, and the virtual character is driven without facial capture or motion capture data, which may be more friendly, convenient, and suitable particularly for a live streamer for a game zone. Facial capture and motion capture are not used, so that occupied computing resources of a computer are greatly reduced. A deterministic motion can be more accurately displayed, for example, a motion of tapping the keyboard or the program-based automatic blink. Multi-dimensional driving may be implemented, thereby ensuring rich motions and facial expressions.

### Embodiment 2

It should be noted that for specific details in this embodiment, reference may be made to Embodiment 1. Details are not repeated herein.

FIG. 9 is a flowchart schematically showing a live streaming method based on a virtual image according to Embodiment 2 of the present application. As shown in FIG. 9, the live streaming method based on a virtual image may include steps S900 and S902.

In step S900, a virtual live streamer interface is displayed, the virtual live streamer interface including a virtual character and a virtual keyboard floating in front of the virtual character.

In step S902, a first animation effect that the virtual character operates the virtual keyboard is displayed in response to an operation for a physical keyboard, where the first animation effect includes that the virtual character taps a target virtual button with a corresponding finger, and the target virtual button corresponds to an operated button of the physical keyboard.

In an optional embodiment, the virtual live streamer interface includes a virtual mouse. The method further includes that:
a second animation effect that the virtual character operates the virtual mouse is displayed in response to an operation for a physical mouse.

When the physical mouse is moved, the second animation effect includes that the virtual character moves a target hand and the virtual mouse by simulating the physical mouse. When a mouse button of the physical mouse is triggered, the second animation effect includes that the virtual character clicks the virtual mouse with a corresponding finger.

In an optional embodiment, the method further includes that:
an animation effect of a blink of the virtual character is displayed in response to a random blink instruction for the virtual character.

In an optional embodiment, the method further includes that:
an animation effect of the head or the upper body of the virtual character is displayed in response to a random motion instruction for the virtual character.

In an optional embodiment, the method further includes:
displaying an animation effect of the face or the mouth of the virtual character in response to an analysis result of a voice signal from a target object.

According to the above solution, a body motion and a facial expression of a virtual character are driven to change based on a motion instruction generated not by image capture. For example, facial-capture-free virtual live streaming may be started by conversion of a voice to a mouth shape, adjustment of a facial expression through voice-based emotion recognition, a random animation, a posture of tapping a keyboard or moving a mouse, or a program-based automatic blink, and the virtual character is driven without facial capture or motion capture data, which may be more friendly, convenient, and suitable particularly for a live streamer for a game zone. Facial capture and motion capture are not used, so that occupied computing resources of a computer are greatly reduced. A deterministic motion can be more accurately displayed, for example, a motion of tapping the keyboard or the program-based automatic blink. Multi-dimensional driving may be implemented, thereby ensuring rich motions and facial expressions.

### Embodiment 3

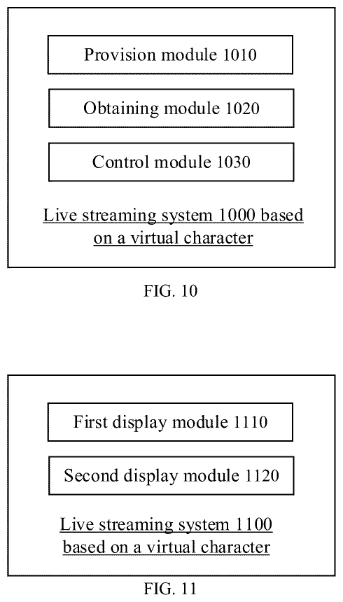

FIG. 10 is a block diagram schematically showing a live streaming system based on a virtual image according to Embodiment 3 of the present application. The live streaming system based on a virtual image may be divided into one or more program modules. The one or more program modules are stored in a storage medium and executed by one or more processors, thereby implementing the embodiments of the present application. The program modules in this embodiment of the present application are a series of computer program instruction segments capable of completing specific functions. The functions of the program modules in this embodiment are specifically described in the following description. As shown in FIG. 10, the live streaming system 1000 based on a virtual image may include a provision module 1010, an obtaining module 1020, and a control module 1030.

The provision module 1010 is configured to provide a live streaming interface, the live streaming interface including a virtual character.

The obtaining module 1020 is configured to obtain a target motion instruction for the virtual character, the target motion instruction being obtained based on an input operation other than image capture.

The control module 1030 is configured to control, in response to the target motion instruction, the virtual character to perform a target motion associated with the target motion instruction.

In an optional embodiment, the input operation includes at least one of the following: a keyboard input, a mouse input, a touchpad input, a voice/text input, a random animation, and a program-setting-based automatic blink.

In an optional embodiment, the obtaining module 1020 is further configured to: obtain a target input signal from a physical device, the physical device comprising a physical keyboard, a physical mouse, and/or a physical touchpad; and determine the target motion instruction based on the target input signal, different input signals corresponding to different motion instructions.

In an optional embodiment, the live streaming interface further includes a virtual keyboard. The virtual keyboard is floatable in front of the virtual character, and is configured to interact with a hand of the virtual character. The obtaining module 1020 is further configured to:
determine a target virtual button of the virtual keyboard when the target input signal is generated by the physical keyboard;
determine a target finger of the virtual character based on the target virtual button; and
determine the target motion instruction based on the target virtual button and the target finger.

The target motion instruction is used for instructing the virtual character to tap the target virtual button with the target finger.

In an optional embodiment, the live streaming interface further includes a virtual mouse. The virtual mouse is floatable beside the virtual character, and is configured to interact with a hand of the virtual character. The obtaining module 1020 is further configured to:
determine a target hand in which the virtual mouse is located when the target input signal is generated by moving the physical mouse; and
determine the target motion instruction based on a location change of the physical mouse.

The target motion instruction is used for instructing the virtual character to move the target hand by simulating the physical mouse.

In an optional embodiment, the live streaming interface further includes a virtual mouse. The virtual mouse is floatable beside the virtual character, and is configured to interact with a hand of the virtual character. The obtaining module 1020 is further configured to:
determine a target virtual button of the virtual mouse when the target input signal is generated by a button of the physical mouse;
determine a target finger of the virtual character; and
determine the target motion instruction based on the target virtual button and the target finger.

The target motion instruction is used for instructing the virtual character to click the virtual mouse with the target finger.

In an optional embodiment, the obtaining module 1020 is further configured to: obtain a random blink instruction for the virtual character, so as to control an eye motion of the virtual character.

In an optional embodiment, the obtaining module 1020 is further configured to: obtain a random motion instruction for the head or the upper body of the virtual character, so as to control a motion of the head or the upper body of the virtual character.

In an optional embodiment, the system further includes a blending module (not shown) configured to:
blend a facial expression motion corresponding to a target emotion with an animation status of the virtual character when the target emotion of the virtual character is determined, different emotions corresponding to motions of different parts of the virtual character.

In an optional embodiment, an operation of determining the target emotion includes:
obtaining a voice audio signal from a target object;
determining an emotion of the target object based on an acoustic feature of the voice audio signal; and
determining the target emotion based on the emotion of the target object, the target emotion being the same as or corresponding to the emotion of the target object.

In an optional embodiment, the obtaining module 1020 is further configured to: perform frequency domain conversion on the voice audio signal to obtain a spectrum; determine a formant on the spectrum;
determine a vowel in the voice audio signal based on the formant;
determine, based on the vowel, a mouth shape corresponding to the voice audio signal; and
determine a mouth motion instruction based on the mouth shape, where the mouth motion instruction is used for instructing a mouth motion of the virtual character.

### Embodiment 4

FIG. 11 is a block diagram schematically showing a live streaming system based on a virtual image according to Embodiment 4 of the present application. The live streaming system based on a virtual image may be divided into one or more program modules. The one or more program modules are stored in a storage medium and executed by one or more processors, thereby implementing the embodiments of the present application. The program modules in this embodiment of the present application are a series of computer program instruction segments capable of completing specific functions. The functions of the program modules in this embodiment are specifically described in the following description. As shown in FIG. 11, the live streaming system 1100 based on a virtual image may include a first display module 1110 and a second display module 1120.

The first display module 1110 is configured to display a virtual live streamer interface, the virtual live streamer interface including a virtual character and a virtual keyboard floating in front of the virtual character.

The second display module 1120 is configured to display, in response to an operation for a physical keyboard, a first animation effect that the virtual character operates the virtual keyboard. The first animation effect includes that the virtual character taps a target virtual button with a corresponding finger, and the target virtual button corresponds to an operated button of the physical keyboard.

In an optional embodiment, the virtual live streamer interface includes a virtual mouse. The second display module 1120 is further configured to:
display, in response to an operation for a physical mouse, a second animation effect that the virtual character operates the virtual mouse.

When the physical mouse is moved, the second animation effect includes that the virtual character moves a target hand and the virtual mouse by simulating the physical mouse. When a mouse button of the physical mouse is triggered, the second animation effect includes that the virtual character clicks the virtual mouse with a corresponding finger.

In an optional embodiment, the second display module 1120 is further configured to:
display an animation effect of a blink of the virtual character in response to a random blink instruction for the virtual character.

In an optional embodiment, the second display module 1120 is further configured to:
display an animation effect of the head or the upper body of the virtual character in response to a random motion instruction for the virtual character.

In an optional embodiment, the second display module 1120 is further configured to:
display an animation effect of the face or the mouth of the virtual character in response to an analysis result of a voice signal from a target object.

### Embodiment 5

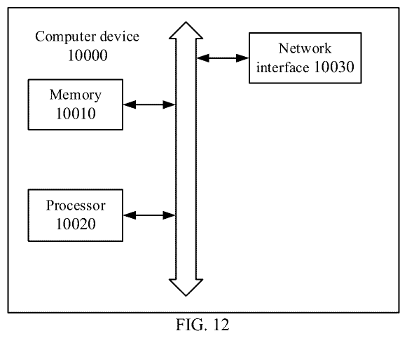

FIG. 12 is a schematic diagram schematically showing a hardware architecture of a computer device suitable for implementing a live streaming method based on a virtual image according to Embodiment 5 of the present application. The computer device 10000 may be a device capable of automatically performing numerical calculation and/or information processing according to preset or prestored instructions, for example, a terminal device such as a smartphone, a tablet computer, a computer, an in-vehicle terminal, a game console, or a virtual device, or a set-top box of an external display device.

In this embodiment, the computer device 10000 may be a device capable of automatically performing numerical calculation and/or information processing according to preset or prestored instructions. As shown in FIG. 12, the computer device 10000 includes, but is not limited to a memory 10010, a processor 10020, and a network interface 10030, which may be communicatively linked to each other by using a system bus, where
the memory 10010 includes at least one type of computer-readable storage medium. The readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 10010 may be an internal storage module of the computer device 10000, for example, a hard disk or an internal memory of the computer device 10000. In some other embodiments, the memory 10010 may alternatively be an external storage device of the computer device 10000, for example, a plug-in hard disk, a smart media card (SMC for short), a secure digital (SD for short) card, or a flash card on the computer device 10000. Certainly, the memory 10010 may alternatively include both an internal storage module and an external storage device of the computer device 10000. In this embodiment, the memory 10010 is generally configured to store an operating system and various application software installed in the computer device 10000, such as program codes for the live streaming method based on a virtual image. In addition, the memory 10010 may be further configured to temporarily store various types of data that have been output or are to be output.

In some embodiments, the processor 10020 may be a central processing unit (CPU for short), a controller, a microcontroller, a microprocessor, or another data processing chip. The processor 10020 is generally configured to control overall operation of the computer device 10000, for example, execute control, processing, and the like related to data interaction or communication with the computer device 10000. In this embodiment, the processor 10020 is configured to run program code stored in the memory 10010 or to process data.

The network interface 10030 may include a wireless network interface or a wired network interface. The network interface 10030 is generally configured to establish a communication link between the computer device 10000 and another computer device. For example, the network interface 10030 is configured to connect the computer device 10000 to an external terminal via a network, and establish a data transmission channel, a communication link, and the like between the computer device 10000 and the external terminal. The network may be a wireless or wired network, such as Intranet, Internet, the Global System for Mobile Communications (GSM for short), wideband code division multiple access (WCDMA for short), a 4G network, a 5G network, Bluetooth, or Wi-Fi.

It should be noted that FIG. 12 shows only a computer device having components 10010-10030, but it should be understood that not all of the illustrated components are required to be implemented, and more or fewer components may be implemented instead.

In this embodiment, the live streaming method based on a virtual image stored in the memory 10010 may further be divided into one or more program modules and performed by one or more processors (which are the processor 10020 in this embodiment), thereby implementing the present application.

### Embodiment 6

This embodiment further provides a computer-readable storage medium, where the computer-readable storage medium stores a computer program that, when executed by a processor, implements the steps of the live streaming method based on a virtual image.

In this embodiment, the computer-readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, for example, a hard disk or an internal memory of the computer device. In some other embodiments, the computer-readable storage medium may alternatively be an external storage device of a computer device, for example, a plug-in hard disk, a smart media card (SMC for short), a secure digital (SD for short) card, or a flash card on the computer device. Certainly, the computer-readable storage medium may alternatively include both an internal storage unit and an external storage device of a computer device. In this embodiment, the computer-readable storage medium is generally configured to store an operating system and various application software that are installed in the computer device, for example, program code for the live streaming method based on a virtual image in this embodiment. In addition, the computer-readable storage medium may be further configured to temporarily store various types of data that have been output or are to be output.

It is apparent to those skilled in the art that the various modules or steps in the above embodiments of the present application may be implemented by a general-purpose computing apparatus, and may be centralized on a single computing apparatus or distributed on a network formed by a plurality of computing apparatuses. Optionally, the various modules or steps may be implemented by using program code executable by the computing apparatus, such that they may be stored in a storage apparatus and executed by the computing apparatus, and in some cases, the steps shown or described may be performed in a sequence different from that described herein, or they may be respectively fabricated into various integrated circuit modules, or a plurality of modules or steps thereof may be implemented as a single integrated circuit module. In this way, the embodiments of the present application are not limited to any specific combination of hardware and software.

It should be noted that the above descriptions are merely preferred embodiments of the present application, and are not intended to limit the patent scope of the present application. Any equivalent structure or equivalent process transformation made using the content of the description and accompanying drawings of the present application, or any direct or indirect application of the content in other related technical fields shall equally fall within the patent protection scope of the present application.

What is claimed is:

1. A method for live streaming based on virtual images, comprising:
presenting a live streaming interface, wherein the live streaming interface comprises a virtual character;
generating a target motion instruction for the virtual character, wherein the target motion instruction is generated based on an input operation other than image capture; and
controlling, in response to the target motion instruction, the virtual character to perform a target motion associated with the target motion instruction.

2. The method according to claim 1, wherein the input operation comprises a keyboard input, a mouse input, a touchpad input, a voice input, a text input, a random animation, and a program-setting-based automatic blink.

3. The method according to claim 1, wherein the generating a target motion instruction for the virtual character further comprises:
receiving a target input signal from a physical device, the physical device comprising at least one of a physical keyboard, a physical mouse, or a physical touchpad; and
determining the target motion instruction based on the target input signal, wherein different input signals correspond to different motion instructions.

4. The method according to claim 1,
wherein the live streaming interface further comprises a virtual keyboard floating in front of the virtual character, and wherein the virtual keyboard is configured to interact with a hand of the virtual character; and
wherein the generating a target motion instruction further comprises:
determining a target virtual button of the virtual keyboard in response to determining that a target input signal is received from and generated by a physical keyboard,
determining a target finger of the virtual character based on the target virtual button, and
generating the target motion instruction based on the target virtual button and the target finger, wherein the target motion instruction is configured to instruct the virtual character to tap the target virtual button with the target finger.

5. The method according to claim 1,
wherein the live streaming interface further comprises a virtual mouse floating beside the virtual character, and wherein the virtual mouse is configured to interact with a hand of the virtual character; and
wherein the generating a target motion instruction further comprises:
determining a target hand in which the virtual mouse is located in response to determining that the target input signal is received from a physical mouse and generated by moving the physical mouse, and
generating the target motion instruction based on a location change of the physical mouse, wherein the target motion instruction is configured to instruct the virtual character to move the target hand by simulating the physical mouse.

6. The method according to claim 1,
wherein the live streaming interface further comprises a virtual mouse floating beside the virtual character, and wherein the virtual mouse is configured to interact with a hand of the virtual character; and
wherein the generating a target motion instruction further comprises:
determining a target virtual button of the virtual mouse in response to determining that the target input signal is received from a physical mouse and generated by a button of the physical mouse,
determining a target finger of the virtual character, and
generating the target motion instruction based on the target virtual button and the target finger, wherein the target motion instruction is configured to instruct the virtual character to click the virtual mouse with the target finger.

7. The method according to claim 1, further comprising:
generating a random blink instruction for the virtual character; and
controlling an eye motion of the virtual character based on the random blink instruction.

8. The method according to claim 1, further comprising:
generating a random motion instruction for a head or an upper body of the virtual character; and
controlling a motion of the head or the upper body of the virtual character based on the random motion instruction.

9. The method according to claim 1, further comprising:
determining a target emotion; and
blending a motion corresponding to the target emotion with an animation status of the virtual character, wherein different target emotions correspond to motions of different parts of the virtual character.

10. The method according to claim 9, wherein the determining a target emotion further comprises:
obtaining voice audio signals from a target object;
determining an emotion of the target object based on acoustic features of the voice audio signals; and
determining the target emotion based on the emotion of the target object, wherein the target emotion is the same as or correspond to the emotion of the target object.

11. The method according to claim 10, further comprising:
performing frequency domain conversion on the voice audio signals to obtain a spectrum;
determining a formant of the spectrum;
determining a vowel in the voice audio signals based on the formant;
determining, based on the vowel, a mouth shape corresponding to the voice audio signals; and
generating a mouth motion instruction based on the mouth shape, wherein the mouth motion instruction is configured to instruct a mouth motion of the virtual character.

12. A computing device, comprising a memory and a processor, wherein the memory stores computer-readable instructions that upon execution by the processor cause the processor to perform operations comprising:
presenting a live streaming interface, wherein the live streaming interface comprises a virtual character;
generating a target motion instruction for the virtual character, wherein the target motion instruction is generated based on an input operation other than image capture; and
controlling, in response to the target motion instruction, the virtual character to perform a target motion associated with the target motion instruction.

13. The computing device according to claim 12, wherein the generating a target motion instruction for the virtual character further comprises:
receiving a target input signal from a physical device, the physical device comprising at least one of a physical keyboard, a physical mouse, or a physical touchpad; and
determining the target motion instruction based on the target input signal, wherein different input signals correspond to different motion instructions.

14. The computing device according to claim 12,
wherein the live streaming interface further comprises a virtual keyboard floating in front of the virtual character, and wherein the virtual keyboard is configured to interact with a hand of the virtual character; and
wherein the generating a target motion instruction further comprises:
determining a target virtual button of the virtual keyboard in response to determining that a target input signal is received from and generated by a physical keyboard,
determining a target finger of the virtual character based on the target virtual button, and
generating the target motion instruction based on the target virtual button and the target finger, wherein the target motion instruction is configured to instruct the virtual character to tap the target virtual button with the target finger.

15. The computing device according to claim 12,
wherein the live streaming interface further comprises a virtual mouse floating beside the virtual character, and wherein the virtual mouse is configured to interact with a hand of the virtual character; and
wherein the generating a target motion instruction further comprises:
determining a target hand in which the virtual mouse is located in response to determining that the target input signal is received from a physical mouse and generated by moving the physical mouse, and
generating the target motion instruction based on a location change of the physical mouse, wherein the target motion instruction is configured to instruct the virtual character to move the target hand by simulating the physical mouse.

16. The computing device according to claim 12,
wherein the live streaming interface further comprises a virtual mouse floating beside the virtual character, and wherein the virtual mouse is configured to interact with a hand of the virtual character; and
wherein the generating a target motion instruction further comprises:
determining a target virtual button of the virtual mouse in response to determining that the target input signal is received from a physical mouse and generated by a button of the physical mouse,
determining a target finger of the virtual character, and
generating the target motion instruction based on the target virtual button and the target finger, wherein the target motion instruction is configured to instruct the virtual character to click the virtual mouse with the target finger.

17. The computing device according to claim 12, the operations further comprising:
generating a random blink instruction for the virtual character; and
controlling an eye motion of the virtual character based on the random blink instruction.

18. The computing device according to claim 12, the operations further comprising:
generating a random motion instruction for a head or an upper body of the virtual character; and
controlling a motion of the head or the upper body of the virtual character based on the random motion instruction.

19. The computing device according to claim 12, the operations further comprising:
determining a target emotion, wherein the determining a target emotion comprises obtaining voice audio signals from a target object and determining an emotion of the target object based on acoustic features of the voice audio signals, and wherein the target emotion is the same as or correspond to the emotion of the target object; and
blending a motion corresponding to the target emotion with an animation status of the virtual character, wherein different target emotions correspond to motions of different parts of the virtual character.

20. A non-transitory computer-readable storage medium, storing computer-readable instructions that upon execution by a processor cause the processor to implement operations comprising:
presenting a live streaming interface, wherein the live streaming interface comprises a virtual character;
generating a target motion instruction for the virtual character, wherein the target motion instruction is generated based on an input operation other than image capture; and
controlling, in response to the target motion instruction, the virtual character to perform a target motion associated with the target motion instruction.
